(19) United States
(12) Patent Application Publication
(10) Pub. No.: US 2008/0176502 A1
(43) Pub. Date: Jul. 24, 2008

(54) Air conditioning apparatus and passage control device with slide resistance generating part

(75) Inventor: Shiho Hashimoto, Chita-gun (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 12/009,301

(22) Filed: Jan. 17, 2008

(30) Foreign Application Priority Data
Jan. 19, 2007 (JP) 2007-010697
Nov. 5, 2007 (JP) 2007-287684

(51) Int. Cl. B60H 1/26

(52) U.S. Cl. 454/145

(57) ABSTRACT

An air conditioning apparatus has a case and a rotatable member that is rotatably supported by the case. The rotatable member and the case define a closed space between opposed surfaces thereof. The closed space is filled with a high-viscosity fluid having a predetermined coefficient of viscosity so as to generate a predetermined resistance to move of the rotatable member. The rotatable member is, for example, a door and a member of a link mechanism that operates the door, such as a lever plate, a link plate or the like.

### CROSS REFERENCE TO RELATED APPLICATION

This application is based on Japanese Patent Applications No. 2007-10697 filed on Jan. 19, 2007 and No. 2007-287684 filed on Nov. 5, 2007, the disclosures of which are incorporated herein by reference.

### FIELD OF THE INVENTION

The present invention relates to an air conditioning apparatus having a rotatable member, such as a door for controlling a passage.

### BACKGROUND OF THE INVENTION

An air conditioning apparatus for a vehicle has a door device, such as an air mix door, for opening and closing a passage defined in an air conditioning case. For example, the air mix door having a substantially plate shape is rotatably supported in a case at a position upstream of a heater core. In a maximum heating mode, the air mix door is moved to a position at which an opening of a cooled air passage through which air cooled by an evaporator flows while bypassing the heater core is closed. In a maximum cooling mode, the air mix door is moved to a position at which an air ventilation surface of the heater core is closed, the air ventilation surface being defined as an opening of a heated air passage. By the operation of the air mix door, a ratio of the volume of air to be heated by the heater core to the volume of air to be introduced in the cooled air passage is controlled.

In such an air mix door, self-induced vibration is likely to be caused depending on valance of a force applied to the air mix door in an air flow. For example, when the air mix door is at a position where the opening of the cooled air passage is slightly opened, that is, when the air mix door is at a position displaced to an upstream position of the air from the maximum heating position by a small angle, the cooled air vigorously flows into the cooled air passage because a resistance to flow of air in the cooled air passage is smaller than that in the heated air passage. Therefore, the velocity of the cooled air passing through a small clearance between the air mix door and a sealing surface of the opening increases.

Because of the air passing through the small clearance, pressure downstream of the air mix door is reduced. Thus, the air mix door receives a force in a direction to close the opening of the cooled air passage. When the opening of the cooled air passage is closed by the air mix door, the force to draw the air mix door to the opening of the cooled air passage disappears. Thus, the air mix door returns to the predetermined position.

If such movements of the air mix door repetitively occur for a short time, a differential pressure between a space upstream of the air mix door and a space downstream of the air mix door pulses. Due to the pulsation of the differential pressure as well as the pulsation of the velocity, the air mix door becomes in an unstable condition, resulting in the self-induced vibration. As a result of the self-induced vibration of the air mix door, noise occurs during an operation of the air conditioning apparatus.

For example, Japanese Unexamined Patent Application Publication No. 9-76726 discloses a door device capable of reducing the self-induced vibration. The disclosed door device has a rotation shaft that is rotatably supported in a case and a door plate, such as an air mix door, integrated with the rotation shaft. A packing member, which is made of urethane, is provided on an upper surface of an end of the door plate. The case has a rib on its upper wall so as to be fitted in the packing member. When the door plate is in a range where an angle between a surface of the door plate and a sealing surface of the case is small, the rib is fitted in the packing member. As such, the door plate is held without causing the self-induced vibration. As a result, noise due to the self-induced vibration of the door plate is reduced.

In fact, an air conditioning apparatus for a vehicle is required to be small so as to increase a space of a passenger compartment. On the other hand, it is required to increase the volume of air, thereby to improve performance. With this, pressure loss in the interior of the air conditioning apparatus tends to be increased. Therefore, pressure exerted to doors in an air conditioning case increases due to the increase in the pressure loss, and hence the self-induced vibrations and noises of the doors are easily increased.

The above matters will be solved by sliding the rib of the door with the packing member as the above disclosed door device, or applying resistance to slide of the door by compressing a packing member. However, the effect of the sliding resistance is likely to be reduced due to deterioration of the packing member over time. Also, noise will occur during the sliding under a low temperature. Further, a sealing effect of the door will be reduced.

### SUMMARY OF THE INVENTION

According to a first aspect of the present invention, an air conditioning apparatus has a case and a rotatable member. The rotatable member is rotatably supported such that a surface of the rotatable member is opposed to a surface of the case and a closed space is provided between the opposed surfaces of the case and the rotatable member. Further, the closed space is filled with a viscous fluid having a predetermined coefficient of viscosity.

Accordingly, a predetermined slide resistance is generated by the viscous fluid when the rotatable member rotates. Further, it is configured such that the resistance increases as a rotational speed of the rotatable member increases. Therefore, self-induced vibration, which is generally rapid movement, of the rotatable member is reduced. Due to the effect of the slide resistance, it is less likely that the rotatable member will generate noise When moving even under a low temperature. Also, a sealing effect of the rotatable member is effectively maintained. Since the viscous fluid is enclosed in the closed space, the resistance is effectively generated. Moreover, deterioration of the viscous fluid is reduced. Thus, the effect of the slide resistance is maintained for a long time.

According to a second aspect of the present invention, a passage control device has a case, a rotatable member and a viscous fluid. The case defines a passage through which a gas such as air flows. The case has a case engagement portion. The rotatable member is configured to be rotatable with respect to the case to control the passage. The rotatable member has a rotational engagement portion that is rotatably engaged with the case engagement portion such that a closed space is provided between the rotational engagement portion and the case engagement portion. The viscous fluid has a predetermined coefficient of viscosity. The closed space is filled with the viscous fluid so that a predetermined slide resistance is generated when the rotatable member rotates.

The rotatable member is, for example, one of a door that is rotatable disposed to open and close the passage and a link member that is coupled to the door for transmitting the rotational force. It is configured such that the resistance increases as a rotational speed of the door increases. Therefore, self-induced vibration, which is generally rapid movement, of the door is reduced. Due to the effect of the slide resistance, it is less likely that the door will generate noise when moving even under a low temperature. Also, a sealing effect of the door is effectively maintained. Since the viscous fluid is enclosed in the closed space, the resistance is effectively generated. Moreover, deterioration of the viscous fluid is reduced. Thus, the effect of the slide resistance is maintained for a long time.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic diagram of an air conditioning apparatus for a vehicle according to a first embodiment of the present invention;

FIG. 2 is a cross-sectional view of a door bearing part of the air conditioning apparatus according to the first embodiment;

FIG. 3 is a cross-sectional view of a door bearing part of an air conditioning apparatus according to a second embodiment of the present invention;

FIG. 4 is a cross-sectional view of a door bearing part of an air conditioning apparatus according to a third embodiment of the present invention;

FIG. 5 is a cross-sectional view of a door bearing part of an air conditioning apparatus according to a fourth embodiment of the present invention;

FIG. 6 is a cross-sectional view of a door bearing part of an air conditioning apparatus according to a fifth embodiment of the present invention;

FIG. 7 is a cross-sectional view of a door bearing part of an air conditioning apparatus according to a sixth embodiment of the present invention;

FIG. 8 is a plan view of a door link part of an air conditioning apparatus according to a seventh embodiment of the present invention;

FIG. 9 is a schematic cross-sectional view of the door link part shown in FIG. 8;

FIG. 10 is a cross-sectional view of a door bearing part of an air conditioning apparatus according to an eighth embodiment of the present invention;

FIG. 11 is a cross-sectional view of a door bearing part of an air conditioning apparatus according to a ninth embodiment of the present invention;

FIG. 12 is a cross-sectional view of a door bearing part of an air conditioning apparatus according to a tenth embodiment of the present invention;

FIG. 13 is a cross-sectional view of a door bearing part of an air conditioning apparatus according to an eleventh embodiment of the present invention;

FIG. 14 is a cross-sectional view of a door bearing part of an air conditioning apparatus according to a twelfth embodiment of the present invention;

FIG. 15 is a cross-sectional view of a door bearing part of an air conditioning apparatus according to a thirteenth embodiment of the present invention;

FIG. 16 is a cross-sectional view of a door bearing part of an air conditioning apparatus according to a fourteenth embodiment of the present invention;

FIG. 17 is a cross-sectional view of a door bearing part of an air conditioning apparatus according to a fifteenth embodiment of the present invention;

FIG. 18 is a cross-sectional view of a door bearing part of an air conditioning apparatus according to a sixteenth embodiment of the present invention;

FIG. 19 is a cross-sectional view of a door bearing part of an air conditioning apparatus according to a seventeenth embodiment of the present invention;

FIG. 20 is a cross-sectional view of a door bearing part of an air conditioning apparatus according to an eighteenth embodiment of the present invention;

FIG. 21 is a cross-sectional view of a door bearing part of an air conditioning apparatus according to a nineteenth embodiment of the present invention;

FIG. 22 is a cross-sectional view of a link plate support part of an air conditioning apparatus according to a twentieth embodiment of the present invention;

FIG. 23 is a cross-sectional view of a link plate support part of an air conditioning apparatus according to a twenty-first embodiment of the present invention;

FIG. 24 is a cross-sectional view of a link plate support part of an air conditioning apparatus according to a twenty-second embodiment of the present invention;

FIG. 25 is a cross-sectional view of a link plate support part of an air conditioning apparatus according to a twenty-third embodiment of the present invention;

FIG. 26 is a cross-sectional view of a link plate support part of an air conditioning apparatus according to a twenty-fourth embodiment of the present invention;

FIG. 27 is a cross-sectional view of a link plate support part of an air conditioning apparatus according to a twenty-fifth embodiment of the present invention;

FIG. 28 is a cross-sectional view of a link plate support part of an air conditioning apparatus according to a twenty-sixth embodiment of the present invention; and

FIG. 29 is a cross-sectional view of a door bearing part of an air conditioning apparatus according to further another embodiment of the present invention.

### DETAILED DESCRIPTION OF EXEMPLARY EMBODIMENTS

Exemplary embodiments of the present invention will be described with reference to the accompanying drawings. In second to twenty-sixth embodiments, components similar to those of the first embodiment will be indicated by the same numerals and will not be described further.

### First Embodiment

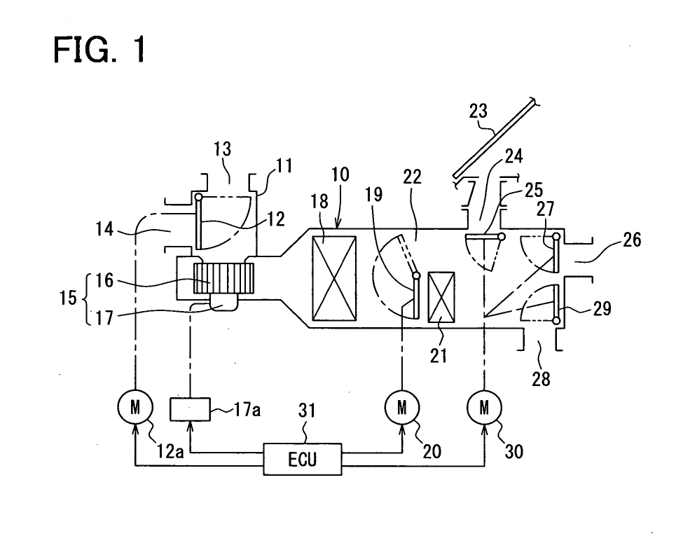

Referring to FIG. 1, a general structure of a vehicular air conditioning apparatus will be first described. The air conditioning apparatus generally has an air conditioning case 10 and air conditioning devices arranged in the case 10.

The air conditioning case 10 is, for example, made of a resin such as polypropylene. The air conditioning case 10 forms an air passage through which air to be introduced to a passenger compartment of a vehicle flows. An inside/outside air switching device 11 is provided at an upstream end of the air conditioning case 10 with respect to a flow of air. The inside/outside air switching device 11 has an inside/outside air switching door 12 that is operable to open and close an outside air suction port 13 and an inside air suction port 14. Thus, outside air (e.g., air outside of a passenger compartment) and inside air (e.g., air inside of a passenger compartment) are selectively introduced into the inside/outside air switching device 11. The inside/outside air switching door 12 is, for example, operated by an electric driving device 12a such as a servomotor.

A blower 15 is provided downstream of the inside/outside air switching device 11 for drawing the inside air and the outside air from the inside/outside air switching device 11 and blowing the air into the case 10. The blower 15 includes a centrifugal multi-blade fan 16 and a motor 17 for driving the fan 16. A voltage applied to the motor 17, that is, a blower voltage, is controlled by a motor driving circuit 17a so as to control a rotation speed of the blower 15, that is, the volume of air to be introduced into the passenger compartment.

An evaporator 18 as a cooling heat exchanger is provided downstream of the blower 15 within the case air conditioning 10. As well-known, the evaporator 18 is a refrigerant evaporator that performs heat exchange between a low pressure refrigerant, which has been decompressed by a decompressing device of a refrigerating cycle (not shown), and the air blown by the blower 15. Thus, the low pressure refrigerant evaporates by heat of the air, and hence the air is cooled.

An air mix door 19 is provided downstream of the evaporator 18 within the air conditioning case 10. Also, a heater core 21 as a heating heat exchanger is provided downstream of the air mix door 19 within the air conditioning case 10. The heater core 21 heats the air that has passed through the evaporator 18 using heat of a heated fluid such as an engine coolant flowing therein. In the air conditioning case 10, a bypass passage (cooled air passage) 22 is formed beside the heater core 21, such as on an upper side of the heater core 21, for allowing the air to bypass the heater core 21.

The air mix door 19 is a rotatable member. For example, the air mix door 19 is a plate door, and is rotated by an electric driving device 20 such as a servomotor through an air mix door link device. The air mix door 19 is operable to open and close an opening of the bypass passage 21 and an opening of a heated air passage through which air passing through the heater core 21 flows.

A position of the air mix door 19, that is, an opening degree of the air mix door 19 is controlled so that a ratio of the volume of the air flowing toward the heater core 21 to be heated to the volume of the cooled air flowing toward the bypass passage 22 is adjusted. Thus, the temperature of air to be introduced into the passenger compartment is controlled by the adjustment of the ratio of heated air to the cooled air.

Namely, in a space defined downstream of the heater core 21, the heated air heated by the heater core 21 and the cooled air passing through the bypass passage 22 are mixed so as to generate the air with a desired temperature. In the present embodiment, the air mix door 19 serves as a device for adjusting the temperature of air to be introduced into the passenger compartment.

The air conditioning case 10 includes an air-blowing mode switching section at a downstream position of the air passage. For example, the air conditioning case 10 has a defroster opening 24 through which air to be blown toward an inner surface of a windshield 23 of the vehicle flows, on a top wall thereof. The defroster opening 24 is opened and closed by a defroster door 25, which is a rotatable plate door, as an air-blowing mode door.

The air conditioning case 10 also has a face opening 26 through which air to be blown toward an upper area of the passenger compartment, such as upper bodies of passengers, flows, on an upper portion of a side wall thereof. The face opening 26 is located on a rear side of the defroster opening 24 with respect to a vehicle front and rear direction. The face opening 26 is opened and closed by a face door 27, which is a rotatable plate door, as an air-blowing mode door.

Further, the air conditioning case 10 has a foot opening 28 through which air to be blown toward a lower area of the passenger compartment, such as lower bodies of passengers, flows, on a lower portion of the side wall thereof. The foot opening 28 is opened and closed by a foot door 29, which is a rotatable plate door, as an air-blowing mode door.

The defroster door 24, the face door 26, and the foot door 28 as the air-blowing mode doors are coupled to a mode door linking device (not shown), and are driven by an electric driving device 30 such as a servomotor through the mode door linking device. The air mix door 19 is coupled to an air mix door linking device and is driven by an electric driving device 20 such as a servomotor through the air mix door linking device.

An air conditioner control unit (ECU) 31 is constructed of a microcomputer including a CPU, a ROM, a RAM and the like, and peripheral circuits. The air conditioner control unit 31 receives sensor signals from various sensors (not shown) and manipulation signals from switches of an air conditioner panel (not shown), and outputs control signals to the electric driving devices 12a, 20, 30, the motor driving circuit 17a and the like.

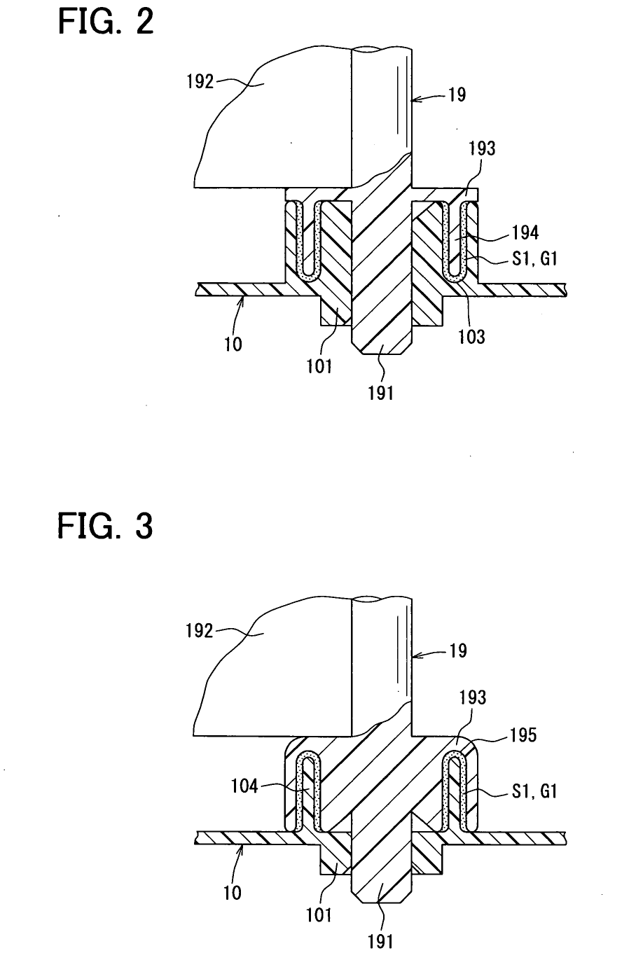

Next, a structure of a door bearing part for rotatably supporting a door (rotatable member) will be described with reference to FIG. 2. Hereinafter, the door bearing part for rotatably supporting the air mix door 19 is described as an example. However, the door to be supported by the door bearing part described later will not be limited to the air mix door 19. The door bearing part may be employed to support any doors or rotatable members.

As shown in FIG. 2, the air mix door 19 generally has a shaft (rotation shaft) 191 and a plate part 192. The shaft 191 is connected to an end of the plate part 192. The air mix door 19 further has a flange (expanded portion) 193 on a radially outside of the shaft 191 and a rotational projection (rotatable-side projection) 194. The flange 193, for example, has a substantially disc shape, so that a diameter of the shaft 191 is increased at the flange 193.

The rotational projection 194 projects from the flange 193 in an axially outward direction, and has a cylindrical shape. That is, the rotational projection 194 projects from an axially outer surface of the flange 193, the outer surface being opposite to the plate part 192 in an axial direction. The rotational projection 194 extends in a circumferential direction, i.e., in a direction of rotation of the shaft 91 with a predetermined distance from a circumferential surface of the shaft 191. In other words, the rotational projection 194 is coaxial with the shaft 191.

The air conditioning case 10 is formed with a shaft hole portion 101 defining a shaft hole for supporting the shaft 191 and a fixed groove portion defining a fixed groove (fixed-side groove) 103 therein for engaging with the rotational projection 194, at a position corresponding to the shaft 191 of the air mix door 19. The fixed groove portion, for example, has a cylindrical shape and extends from the air conditioning case 10. The fixed groove 103 has an annular shape and is formed on a radially outer side of the shaft hole portion 101.

The rotational projection 194 is received in the fixed groove 103 such that a closed space S1 is provided between them. The closed space S1 has a predetermined width, that is a dimension in a radial direction. The dimension of the closed space S1 is uniform in the circumferential direction. Also, the closed space S1 is continuous from an outer circumferential side of the rotational projection 194 to an inner circumferential side of the rotational projection 194 through an end of the rotational projection 194. In other words, the closed space S1 is also formed between the end of the rotational projection and a bottom surface of the fixed groove 103. For example, the closed space S1 has a substantially U-shape in a cross-section defined in an axial direction, as shown in FIG. 2.

Further, the closed space S1 is filled with a high-viscosity fluid (viscous fluid) having a predetermined coefficient of viscosity, such as a high-viscosity grease G1, so as to generate predetermined resistance to slide of the air mix door 19 (hereafter, slide resistance) when the air mix door 19 rotates. The axially outer surface of the flange 193 is in contact with an end surface of the fixed groove portion 103 to restrict leakage of the grease G1 from the closed space S1.

Next, features and effects of the present embodiment will be described.

In the air conditioning apparatus, the closed space S1 is provided between opposed surfaces of the air conditioning case 10 and the air mix door 19, and the closed space S1 is filled with the high-viscosity grease G1. Therefore, when the air mix door 19 rotates, the slide resistance is generated by the high-viscosity grease G1. The slide resistance increases as the rotational speed of the air mix door 19 increases. As such, the slide resistance is effectively generated against rapid movement of the air mix door 19, such as the self-induced vibration. Accordingly, the self-induced vibration of the air mix door 19 is reduced.

Further, because of the above characteristic of the slide resistance, it is less likely that noise due to sliding will be generated even under a low temperature. Also, a sealing effect of the air mix door 19 is maintained. Moreover, since the closed space S1 is configured such that the leakage of the high-viscosity grease G1 is restricted, the slide resistance is effectively generated. Also, because deterioration of the high-viscosity grease G1 over time is reduced, the effect of the high-viscosity grease G1 is maintained for a long time.

For example, the air mix door 19 has the flange 193 on the periphery of the shaft 191 and the rotational projection 194 projecting from the flange 193 in the form of cylinder. The air conditioning case 10 has the fixed groove 103 on the periphery of the support hole 101. The closed space S1 is provided between an inner surface of the fixed groove 103 and an outer surface (e.g., inner and outer circumferential surfaces) of the rotational projection 194, the outer surface being opposed to the inner surface of the fixed groove 103.

Also, the closed space S1 is continuous from the radially inner side of the rotational projection 194 to the radially outer side of the rotational projection 194 through the end of the rotational projection 194. In other words, the closed space S1 is also formed between the end of the rotational projection 194 and the bottom wall of the fixed groove 103. As such, even in the movement in the thrust direction of the rotation shaft 191, noise is reduced.

The air mix door 19 is the rotatable member that opens and closes the opening of the bypass passage 22 of the air conditioning case 10. The air mix door 19 has the rotational projection 194 as an engagement portion, and the air conditioning case 10 has the fixed groove 103 as an engagement portion that engages with the engagement portion of the air mix door 19. The closed space S1 is provided between the engagement portions of the air mix door 19 and the air conditioning case 10, and is filled with the high-viscosity grease G1. Thus, the self-induced vibration of the air mix door 19 is reduced by the slide resistance generating part provided between the engagement portions.

In the air conditioning case 10, the heater core 21 is disposed downstream of the evaporator 18 for heating the cooled air that has been cooled by the evaporator 18. The heated air passage through which the air passing through the heater core 21 flows and the bypass passage 22 through which the cooled air bypasses the heater core 21 are provided in the air conditioning case 10. The air mix door 19 is located upstream of the heater core 21. The air mix door 19 is rotatable between a maximum heating position at which the opening of the heated air passage is open and the opening of the bypass passage 22 is closed and a maximum cooling position at which the opening of the heated air passage is closed and the opening of the bypass passage 22 is open. Thus, an opening ratio of the opening of the heated air passage to the opening of the bypass passage 22 can be controlled by the air mix door 19.

Since the heater core 21 is located in the heated air passage, resistance to flow of the air at the opening of the bypass passage 22 is smaller than that at the opening of the heated air passage. Therefore, when the air mix door 19 is moved to a position at which the opening of the bypass passage 22 is slightly opened, momentum of the cooled air flowing into the bypass passage 22 through a small clearance defined between the air mix door 19 and the opening of the bypass passage 22 increases. In the present embodiment, since the slide resistance generating part is provided between the air mix door 19 and the air conditioning case 10, the self-induced vibration and noise of the air mix door 19 are reduced even when the air mix door 19 is in the above position.

### Second Embodiment

Referring to FIG. 3, in the second embodiment, the door bearing part has the projection and the groove in a manner opposite to that of the first embodiment. For example, the air mix door 19 has the expanded portion 193 having the substantially disc shape on the periphery of the shaft 191. The expanded portion 193 has a rotational groove (rotatable-side groove) 195 on an axially outer surface thereof. The rotational groove 195 is open in the axially outward direction of the air mix door 19. The rotational groove 195 has an annular shape that extends in the rotational direction of the air mix door 19. In other words, the annular rotational groove 195 is coaxial with the rotational axis of the shaft 191.

The air conditioning case 10 has the shaft hole 101 for supporting the shaft 191 and a fixed projection (fixed-side projection) 104 on the periphery of the shaft hole 101. The fixed projection 104 projects from an inner surface of the air conditioning case 10 and has a cylindrical shape to engage with the rotational groove 195.

Further, the fixed projection 104 and the rotational groove 195 are engaged such that the closed space S1 is provided between them. The dimension of the closed space S1 is uniform in the circumferential direction. The closed space S1 is also formed between the end of the fixed projection 104 and the bottom of the rotational groove 195. Thus, the closed space S1 has the substantially U-shape in a cross-section defined in the axial direction, as shown in FIG. 3.

The closed space S1 is filled with the high-viscosity grease G1 so as to generate the predetermined slide resistance when the air mix door 19 rotates. Here, the axially outer surface of the expanded portion 193 is in contact with the inner surface of the air conditioning case 10 so as to restrict leakage of the high-viscosity grease G1 from the closed space S1.

Accordingly, in the present embodiment, the effects similar to those of the first embodiment will be provided.

### Third Embodiment

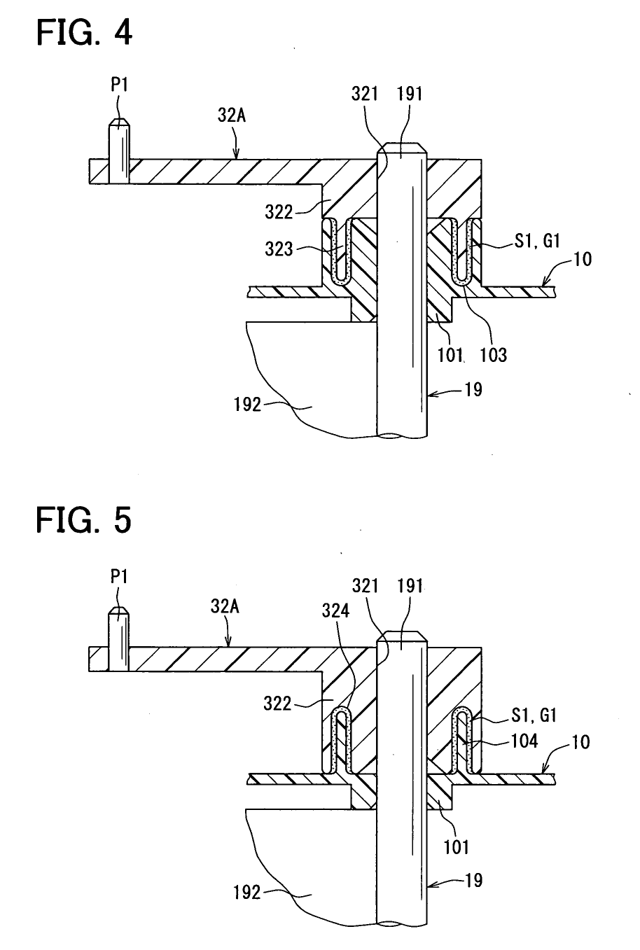

Referring to FIG. 4, in the third embodiment, the door bearing part is constructed of engagement portions of the air conditioning case 10 and a lever plate 32A. Here, the lever plate 32A serves as the rotational member. The lever plate 32A is coupled to the air mix door 19 to transmit a rotational force to the air mix door 19.

The shaft 191 of the air mix door 19 passes through the shaft hole portion 101 of the air conditioning case 10 and projects to the outside of the air conditioning case 10. The shaft 191 is further inserted to a shaft receiving hole (rotational shaft hole) 321 of the lever plate 32A. The lever plate 32A is disposed such that a lever portion thereof extends in a predetermined direction through a positioning mechanism (not shown). The lever portion has a link pin P1 on an end opposite to the shaft receiving hole 321 and is coupled to a driving device through the link pin P1. The lever plate 32A is, for example, a member of the air mix door linking device.

In the present embodiment, the air mix door 19 does not have the expanded portion 193 as the first and second embodiments. Instead, the lever plate 32A has an expanded portion 322, which, for example, has a substantially disc shape, on the periphery of the shaft receiving hole 321. For example, the expanded portion 322 has a thickness that is greater than a thickness of the lever portion, and has an outer diameter that is greater than a diameter of the shaft 191.

The expanded portion 322 has a rotational projection (rotatable-side projection) 323 on its surface facing the air conditioning case 10. The rotational projection 323 has a cylindrical shape that is coaxial with the shaft 191.

The air conditioning case 10 has the shaft hole portion 101 defining the shaft hole and the fixed groove portion 103 on the periphery of the shaft hole portion 101. In the present embodiment, the fixed groove portion 103 is formed on an outer surface of the air conditioning case 10, and forms the annular fixed groove to receive the rotational projection 323 of the lever plate 32A.

Further, the fixed groove portion 103 and the rotational projection 323 are engaged such that the closed space S1 is provided between them. The dimension of the closed space S1 is uniform in the circumferential direction. The closed space S1 is also formed between the end of the rotational projection 323 and the fixed groove 103. In other words, the closed space S1 is formed continuously from an inner circumferential side of the rotational projection 323 to an outer circumferential side of the rotational projection 323 through the end of the rotational projection 323. Thus, the closed space S1 has a substantially U-shape in a cross-section defined in the axial direction, as shown in FIG. 4.

The closed space S1 is filled with the high-viscosity grease G1 so as to generate the predetermined slide resistance when the air mix door 19 rotates. The surface of the expanded portion 322, which faces the air conditioning case 10 and forms a base portion of the rotational projection 323, is in contact with the end surface of the fixed groove portion 103 so as to restrict leakage of the high-viscosity grease G1 from the closed space S1.

In the present embodiment, the slide resistance generating part is provided by the engagement portions formed between the air conditioning case 10 and the member that is coupled to the air mix door 19, which needs measures. Also in this case, the self-induced vibration and the noise of the air mix door 19 are reduced.

### Fourth Embodiment

Referring to FIG. 5, in the fourth embodiment, the relationship between the projection and the groove is reversed from that of the third embodiment. For example, the expanded portion 322 of the lever plate 32A has a rotational groove (rotatable-side groove) 324 on a side that faces the air conditioning case 10, in place of the rotational projection 323. The air conditioning case 10 has the fixed projection 104 for engaging with the rotational groove 324, in place of the fixed groove 103.

The rotational groove 324 is formed on the periphery of the shaft receiving hole 321, and has an annular shape extending in the rotational direction. The fixed projection 104 projects toward the expanded portion 322 of the link lever 32A from the outer surface of the air conditioning case 10 on the periphery of the shaft hole 101, and has a cylindrical shape to be coaxial With the shaft 191.

The fixed projection 104 is received in the rotational groove 324 such that the closed space S1 is provided between them. The dimension of the closed space S1 is uniform in the circumferential direction. The closed space S1 is also formed between the end of the fixed projection 104 and the bottom of the rotational groove 324. That is, the closed space S1 is formed continuously from the outer circumferential side of the fixed projection 104 to the inner circumferential side of the fixed projection 104 through the end of the fixed projection 104. Thus, the closed space S1 has a substantially U-shape in a cross-section defined in the axial direction, as shown in FIG. 5.

The closed space S1 is filled with the high-viscosity grease G1 so as to generate the predetermined slide resistance when the air mix door 19 rotates. In this case, the outer surface of the air conditioning case 10 is in contact with the surface of the expanded portion 322 so as to restrict leakage of the high-viscosity grease G1 from the closed space S1.

Accordingly, also in the present embodiment, the effects similar to the third embodiment will be provided.

### Fifth Embodiment

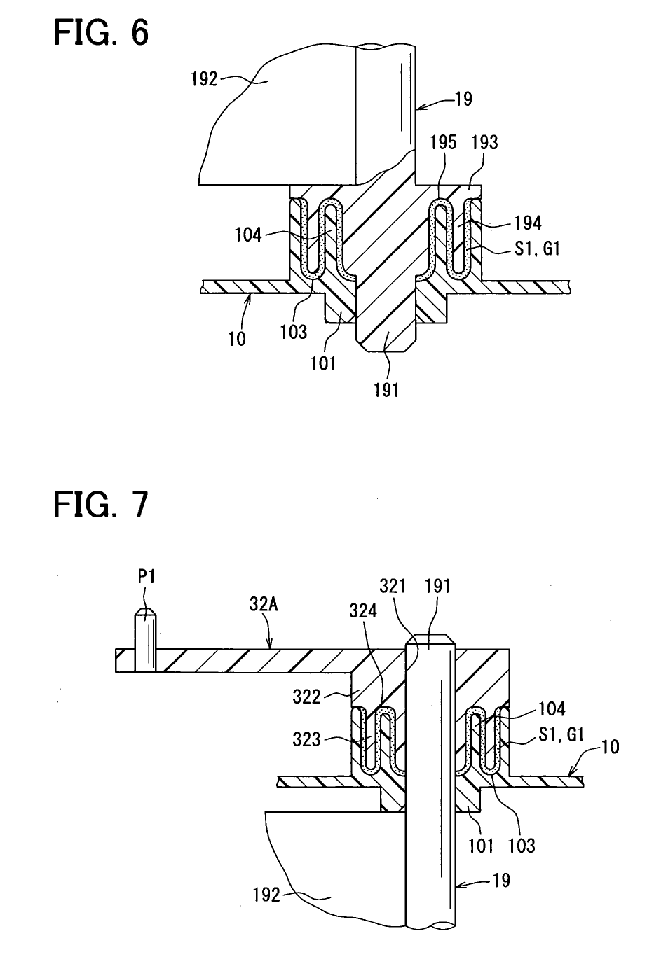

Referring to FIG. 6, in the fifth embodiment, the door bearing part has the closed space S1 that has a shape modified from those of the first and second embodiments. For example, the air mix door 19 and the air conditioning case 10 have plural engagement portions, such as the projections and the grooves, respectively.

As shown in FIG. 6, the air mix door 19 has the rotational projection 194 and the rotational groove 195, and the air conditioning case 10 has the fixed groove 103 and the fixed projection 104. The rotational projection 194 has the cylindrical shape, and the rotational groove 195 is formed on an inner circumferential side of the rotational projection 194. The fixed projection 104 has the cylindrical shape, and the fixed groove 103 is formed on an outer circumferential side of the fixed projection 104.

The air mix door 19 is connected to the case 10 such that the rotational projection 194 and the rotational groove 195 are engaged with the fixed groove 103 and the fixed projection 104, respectively, and the closed space S1 is provided between them. The closed space S1 is filled with the high-viscosity grease G1 so as to generate the predetermined slide resistance when the air mix door 19 rotates.

In the present embodiment, since the numbers of the grooves and projections are increased, the slide resistance is increased, as compared with the first and second embodiments.

In this case, the axial dimension of the grooves and projections can be reduced so that the slide resistance is equal to those of the structures of the above embodiments. Thus, the slide resistance generating part can be reduced in size.

In the present embodiment, the relationship between the projections and grooves shown in FIG. 6 may be reversed in the up and down direction. Also in this case, the similar effects will be provided.

### Sixth Embodiment

Referring to FIG. 7, in the sixth embodiment, the door bearing part has plural engagement portions, such as the projections and the grooves, between the lever plate 32A and the air conditioning case 10. For example, the lever plate 32A has the rotational projection 323 and the rotational groove 324, and the air conditioning case 10 has the fixed groove 103 and the fixed projection 104.

The rotational groove 324 is formed on an inner circumferential side of the rotational projection 323. The fixed groove 103 is formed on an outer circumferential side of the fixed projection 104. The rotational groove 324 and the rotational projection 323 are engaged with the fixed projection 104 and the fixed groove 103, respectively, through the closed space S1.

Since the numbers of the projections and grooves of the slide resistance generating part are increased, the slide resistance is increased, as compared with the third and forth embodiments.

In this case, the axial dimension of the grooves and projections can be reduced so that the slide resistance is equal to those of the structures of the third and forth embodiments. Thus, the slide resistance generating part can be reduced in size.

In the present embodiment, the relationship between the projections and grooves shown in FIG. 7 may be reversed in the up and down direction. Also in this case, the similar effects are provided.

### Seventh Embodiment

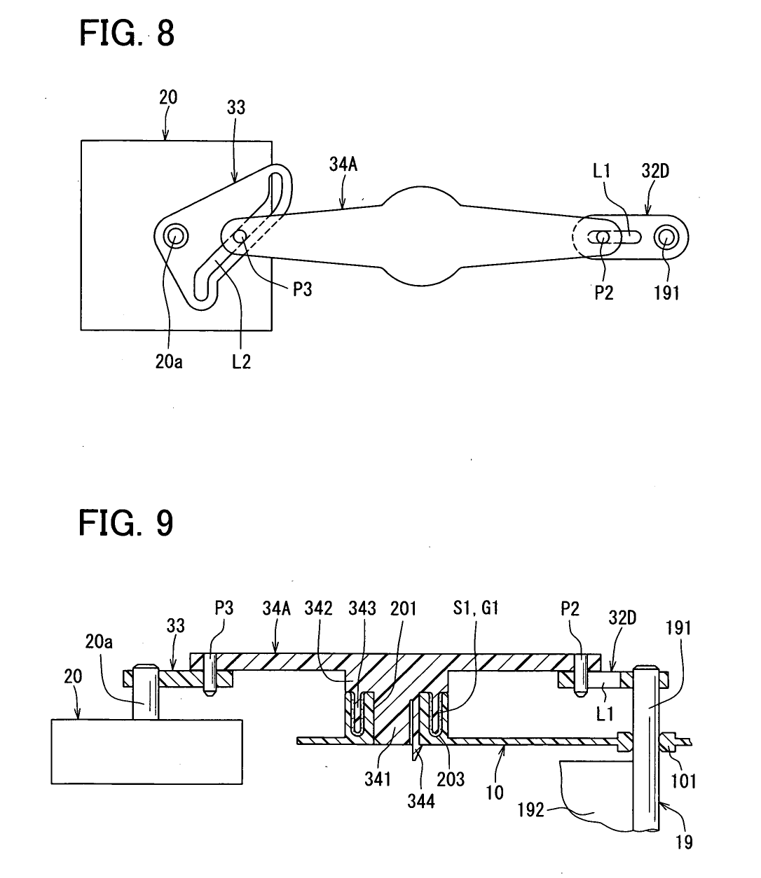

Referring to FIGS. 8 and 9, in the seventh embodiment, the slide resistance generating part is exemplarily employed to a bearing part of a link plate 34A of the air mix door linking device (e.g., door link part). The link plate 34A is coupled to the air mix door 19 through a lever plate 32D for transmitting a rotational force to the air mix door 19. Here, the link plate 34A serves as the rotational member.

The shaft 191 of the air mix door 19 passes through the shaft hole 101 of the air conditioning case 10. The lever plate 32D is engaged with the end of the shaft 191, and extends in a predetermined direction through a positioning mechanism (not shown). The lever plate 32D is formed with a link opening L1 to be connected to a first link pin P2 of a first end of the link plate 34A.

The driving device 20 is, for example, a servomotor, and has a driving shaft 20a. The driving shaft 20a is coupled to a driving-side lever plate 33. The lever plate 33 is formed with a link opening L2. A second end of the lever plate 34A has a second link pin P3. The second link pin P3 is received in the link opening L2 of the driving-side lever plate 33.

The link plate 34A has a boss portion (rotation shaft) 341 projecting toward the air conditioning case 10. The boss portion 341 is integrally formed with an engagement piece 344. The boss portion 341 is received in a shaft hole 210 of the air conditioning case 10 and is rotatably held by the engagement piece 344.

Further, the link plate 34A has an expanded portion 342 on the periphery of the boss portion 341. The expanded portion 342, for example, has an outer diameter greater than that of the boss portion 341. For example, the expanded portion 342 has a substantially disc shape. The expanded portion 342 has a rotational projection (rotatable-side projection) 343 projecting toward the air conditioning case 10. The rotational projection 343 has a cylindrical shape that extends in the direction of rotation. That is, the rotational projection 343 is coaxial with the boss portion 341.

The air conditioning case 10 further has a fixed groove portion 203 defining a fixed groove (fixed-side groove) on the periphery of the shaft hole 201 for receiving the rotational projection 343 of the link plate 34A. The fixed groove 203 has an annular shape. The closed space S1 is provided between the rotational projection 343 and the fixed groove 103. The dimension of the closed space S1 is uniform in a circumferential direction.

The closed space S1 is also formed between the end of the rotational projection 343 and the bottom of the fixed groove 203. That is, the closed space S1 is formed continuously from an outer circumferential side of the rotational projection 343 to an inner circumferential side of the rotational projection 343 through the end of the rotational projection 343. Thus, the closed space S1 has a substantially U-shape in a cross-section defined in the axial direction, as shown in FIG. 9.

The closed space S1 is filled with the high-viscosity grease G1 to generate the predetermined slide resistance when the door 19 rotates. An axial end surface of the expanded portion 342 is in contact with the end surface of the fixed groove portion 203 so as to restrict leakage of the high-viscosity grease G1 from the closed space S1.

In the present embodiment, the slide resistance generating part is formed between the air conditioning case 10 and the link plate 34A that is connected to the air mix door 19, which needs measures. Also in this construction, the self-induced vibration and noise of the air mix door 19 is reduced.

### Eighth Embodiment

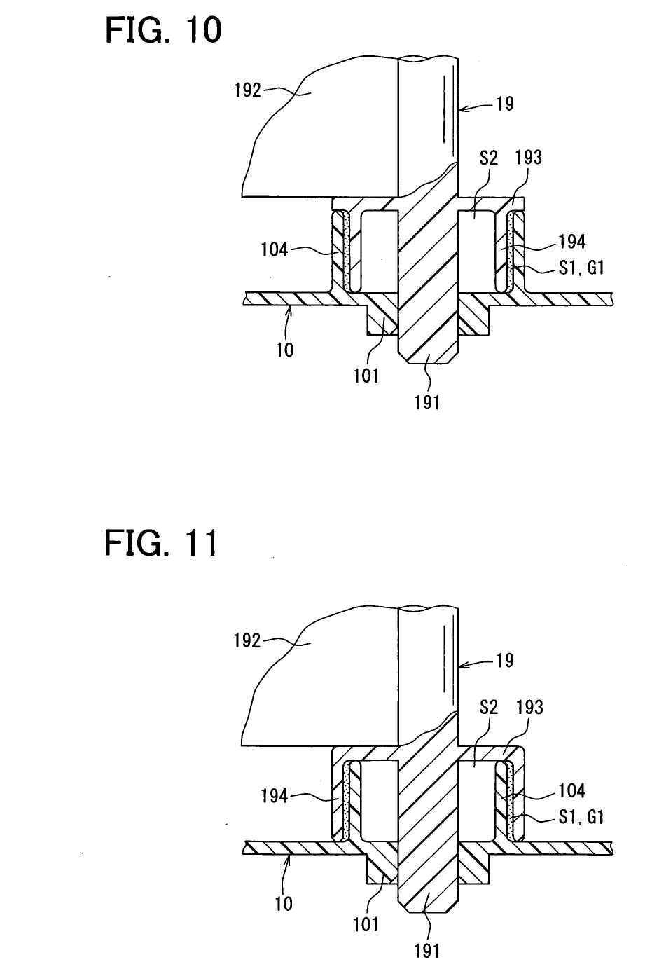

Referring to FIG. 10, in the eighth embodiment, the air mix door 19 has the expanded portion 193 having a flange-like or disc shape on a periphery of the shaft 191. The air mix door 19 further has the rotational projection 194 that projects from the axially outer surface of the expanded portion 193. The rotational projection 194 has the cylindrical shape and is coaxial with the shaft 191.

The air conditioning case 10 has the fixed projection 104 on the periphery of the shaft hole 101. The fixed projection 104 projects from the inner surface of the air conditioning case 10 toward the expanded portion 193. The fixed projection 104 has a cylindrical shape and has an inner diameter larger than an outer diameter of the rotational projection 194. The rotational projection 194 is received in the space defined by the cylindrical fixed projection 104 such that an outer circumferential surface of the rotational projection 194 is opposed to an inner circumferential surface of the fixed projection 104.

Further, the closed space S1 is provided between the outer circumferential surface of the rotational projection 194 and the inner circumferential surface of the fixed projection 104. The dimension of the closed space S1 is uniform in the circumferential direction. The closed space S1 is filled with the high-viscosity grease G1 so as to generate the predetermined slide resistance when the air mix door 19 rotates.

The end of the rotational projection 194 is in contact with the inner surface of the air conditioning case 10, and the end of the fixed projection 104 is in contact with the axially outer surface of the expanded portion 193. Thus, the leakage of the high-viscosity grease G1 is restricted.

In the present embodiment, the rotational projection 194 has the cylindrical shape, and a space S2 is provided between an outer surface of the shaft 191 and an inner surface of the rotational projection 194. Even in this configuration, the closed space S1 is provided between the opposed surfaces of the air mix door 19 and the air conditioning case. The self-induced vibration and noise of the air mix door 19 is reduced by the slide resistance generated by the high-viscosity grease G1.

### Ninth Embodiment

Referring to FIG. 11, in the ninth embodiment, the relationship between the rotational projection 194 and the fixed projection 104 is reversed from that of the eighth embodiment shown in FIG. 10. The rotational projection 194 is located on an outer circumferential side of the fixed projection 104. The closed space S1 is provided between an inner circumferential surface of the rotational projection 194 and an outer circumferential surface of the fixed projection 104. The closed space S1 is filled with the high-viscosity grease G1 so as to generate the predetermined slide resistance when the air mix door 19 rotates.

Also in this structure, the closed space S1 that is filled with the high-viscosity grease G1 is provided between the opposed surfaces of the air conditioning case 10 and the air mix door 19. Thus, the effects of the slide resistance will be provided, similar to the above embodiments.

### Tenth Embodiment

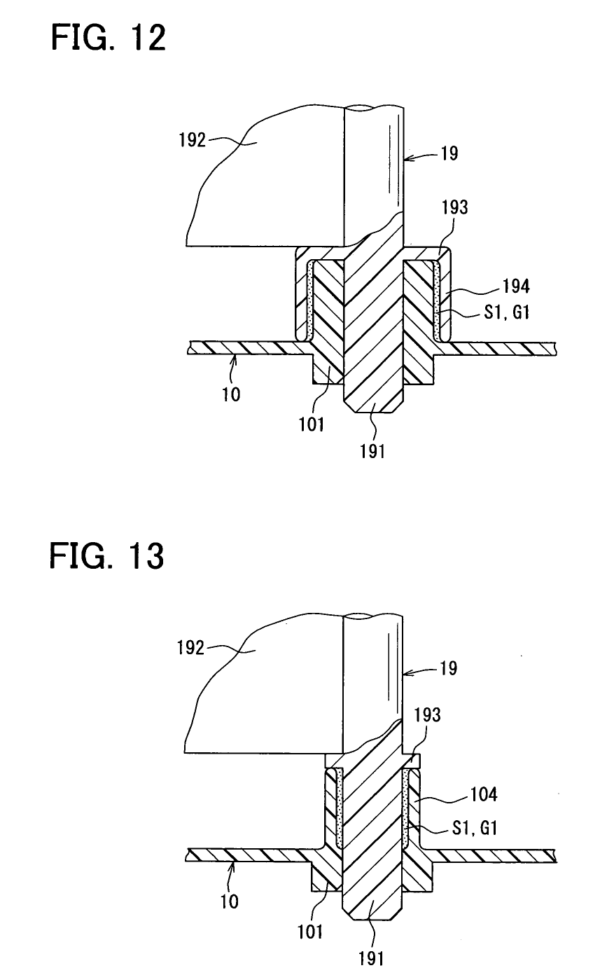

Referring to FIG. 12, in the tenth embodiment, the bearing part is modified from that of the ninth embodiment shown in FIG. 11. The tenth embodiment is different from the ninth embodiment because the closed space S1 is provided by an outer circumferential surface of the shaft hole portion 101, in place of the outer circumferential surface of the fixed projection 104 of the ninth embodiment.

The air mix door 19 has the expanded portion 193 that expends from the shaft 191 in the form of disc and the rotational projection 194. The rotational projection 194 projects from the axially outer surface of the expanded part 193 and has the cylindrical shape to be coaxial with the shaft 191.

The air conditioning case 10 has the shaft hole portion 101 that projects from the inner surface of the air conditioning case 10 toward the inside of the air conditioning case 10. The shaft 191 passes through the opening defined in the shaft hole portion 101. The shaft hole portion 101 is received in the cylindrical rotational projection 194, and the closed space S1 is provided between the outer circumferential surface of the shaft hole portion 101 and the inner circumferential surface of the rotational projection 194. The closed space S1 is filled with the high-viscosity grease G1 so as to generate the predetermined slide resistance when the door 19 rotates.

Also in the present embodiment, the closed space S1 that is filled with the high-viscosity grease G1 is provided between the opposed surfaces of the air conditioning case 10 and the air mix door 19. As such, the effect of the slide resistance will be provided, similar to the above embodiments.

### Eleventh Embodiment

Referring to FIG. 13, in the eleventh embodiment, the air mix door 19 has the expanded portion 193 that expands from the shaft 191 and has the disc shape. The air conditioning case 10 has the fixed projection 104 at the position corresponding to the shaft hole part 101. The fixed projection 104 projects from the inner surface of the case 10 toward the air mix door 19 and has the cylindrical shape.

The closed space S1 is provided between the outer surface of the shaft 191 and the inner circumferential surface of the fixed projection 104. The closed space S1 is filled with the high-viscosity grease G1 to generate the predetermined slide resistance when the air mix door 19 rotates. Also in this case, the end of the fixed projection 104 is in contact with the axially outer surface of the expanded portion 193. Thus, it is less likely that the high-viscosity grease G1 will leak out from the closed space S1.

Also in the present embodiment, the closed space S1 that is filled with the high-viscosity grease G1 is provided between the opposed surfaces of the air conditioning case 10 and the air mix door 19. As such, the effect of the slide resistance will be provided, similar to the above embodiments.

### Twelfth Embodiment

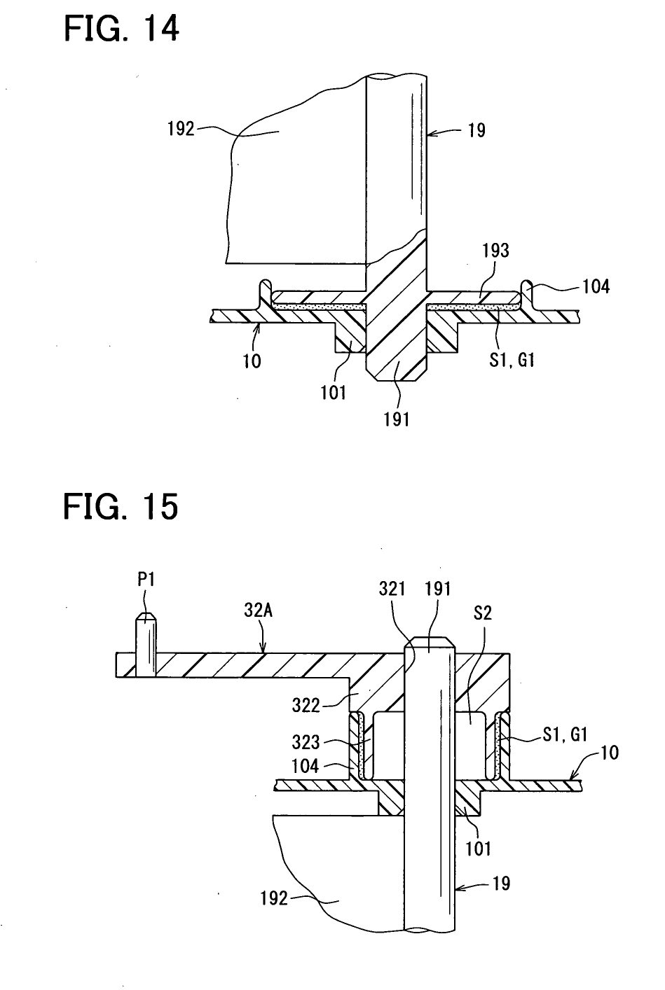

Referring to FIG. 14, in the twelfth embodiment, the air mix door 19 has the expanded portion 193 that expands from the shaft 191 and has the disc shape. The air conditioning case 10 has the fixed projection 104 on the periphery of the shaft hole 101 to correspond to the expanded portion 193.

The fixed projection 104 projects from the inner surface of the air conditioning case 10 toward the air mix door 19 and surrounds the expanded part 193 of the air mix door 19. In other words, the fixed projection 104 has the cylindrical shape having an inside diameter that corresponds to an outside diameter of the expanded part 193. The expanded part 193 is received in the fixed projection 104. The outer end of the expanded part 193 is in contact with the inner circumferential surface of the fixed projection 104.

Further, the closed space S1 is provided between the inner surface of the air conditioning case 10 and the axially outer surface of the expanded part 193, which is opposed to the inner surface of the air conditioning case 10 in the axial direction. The closed space S1 is filled with the high-viscosity grease G1 so as to generate the predetermined slide resistance when the air mix door 19 rotates.

Also in the present embodiment, the closed space S1 that is filled with the high-viscosity grease G1 is provided between the opposed surfaces of the air conditioning case 10 and the air mix door 19. As such, the effects of the slide resistance will be provided, similar to the above embodiments.

### Thirteenth Embodiment

Referring to FIG. 15, in the thirteenth embodiment, the door bearing part is constructed by employing the slide resistance generating part of the eighth embodiment between the lever plate 32A and the air conditioning case 10. Specifically, the lever plate 32A has the expanded portion 322 on the periphery of the shaft receiving hole 321 through which the shaft 191 passes. The expanded portion 322 has the substantially disc shape. The lever plate 32A further has the rotational projection 323 that projects from the surface of the expanded part 322 toward the air conditioning case 10, the surface facing the air conditioning case 10. The rotational projection 323 has the cylindrical shape and is coaxial with the shaft 191.

The air conditioning case 10 has the fixed projection 104 on the periphery of the shaft hole 101. The fixed projection 104 has the cylindrical shape and projects from the outer surface of the air conditioning case 10. The rotational projection 323 is received in the fixed projection 104 such that the closed space S1 is provided between the outer circumferential surface of the rotational projection 323 and the inner circumferential surface of the fixed projection 104. The closed space S1 is filled with the high-viscosity grease G1 so as to generate the predetermined slide resistance when the air mix door 19 rotates.

Accordingly, also in the present embodiment, the effects similar to the above embodiments will be provided.

### Fourteenth Embodiment

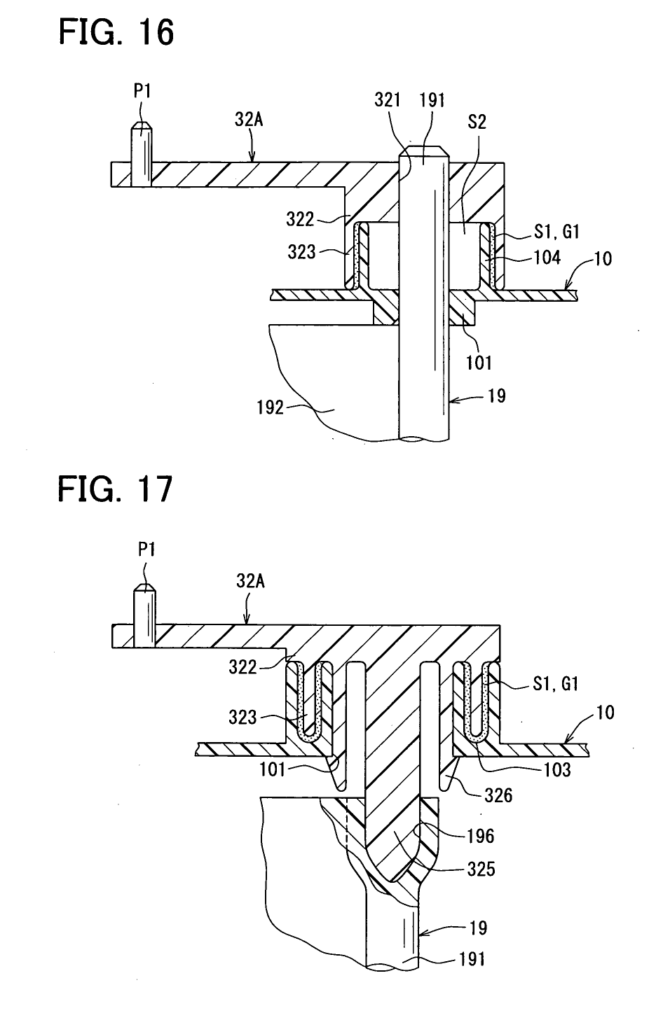

Referring to FIG. 16, in the fourteenth embodiment, the door bearing part has the similar structure as that of the thirteenth embodiment, but the relationship between the rotational projection 323 and the fixed projection 104 is reversed.

As shown in FIG. 16, the fixed projection 104 of the air conditioning case 10 is located on an inner circumferential side of the rotational projection 323 of the lever plate 32A, and the closed space S1 is provided between the outer circumferential surface of the fixed projection 104 and the inner circumferential surface of the rotational projection. 323. The closed space S1 is filled with the high-viscosity grease G1 so as to generate the predetermined slide resistance, similar to the thirteenth embodiment.

### Fifteenth Embodiment

Referring to FIG. 17, in the fifteenth embodiment, the lever plate 32A has a pin 325 that projects from the expanded part 322 as the rotational shaft, instead of the shaft receiving hole 321. The end of the shaft 191 is formed with a pin receiving hole (rotational shaft hole) 196 for receiving the pin 325 of the lever plate 32A. The pin 325 passes through the shaft hole 101 of the air conditioning case 10 and extends to the inside of the air conditioning case 10.

The lever plate 32A further has an engagement piece 326. The engagement piece 326 is engaged with the shaft hole 101 so that the lever plate 32A is rotatably held by the air conditioning case 10.

In the present embodiment, the slide resistance generating part of the third embodiment is employed to the bearing part between the air conditioning case 10 and the lever plate 32A that is coupled to the air mix door 19 in the above described manner. Specifically, the lever plate 32A has the rotational projection 323 that projects from the expanded part 322 and has the cylindrical shape to be coaxial with the pin 325. The rotational projection 323 projects to toward the air conditioning case 10.

The air conditioning case 10 has the fixed groove portion 103 on the periphery of the shaft hole 101 on the outside of the air conditioning case 10. The fixed groove portion 103 forms the annular fixed groove to engage with the rotational projection 323.

The rotational projection 323 is received in the fixed groove of the fixed groove portion 103 such that the closed space S1 is provided between them. The closed space S1 is provided uniformly in the circumferential direction. The closed space S1 is continuous from the inner circumferential side of the rotational projection 323 to the outer circumferential side of the rotational projection 323 through the end of the rotational projection 323. That is, the closed space S1 is also formed between the end of the rotational projection 323 and the bottom of the fixed groove of the fixed groove portion 103. The closed space S1 is filled with the high-viscosity grease G1 so as to generate the predetermined slide resistance when the air mix door 19 rotates.

Even in the construction of the fifteenth embodiments, the effects similar to the above embodiments will be provided.

In the present embodiment, the engagement piece 326 may have a substantially cylindrical shape. Alternatively, the lever plate 32A may have plural engagement pieces 326 as long as the lever plate 32A is rotatably held by the air conditioning case 10.

### Sixteenth Embodiment

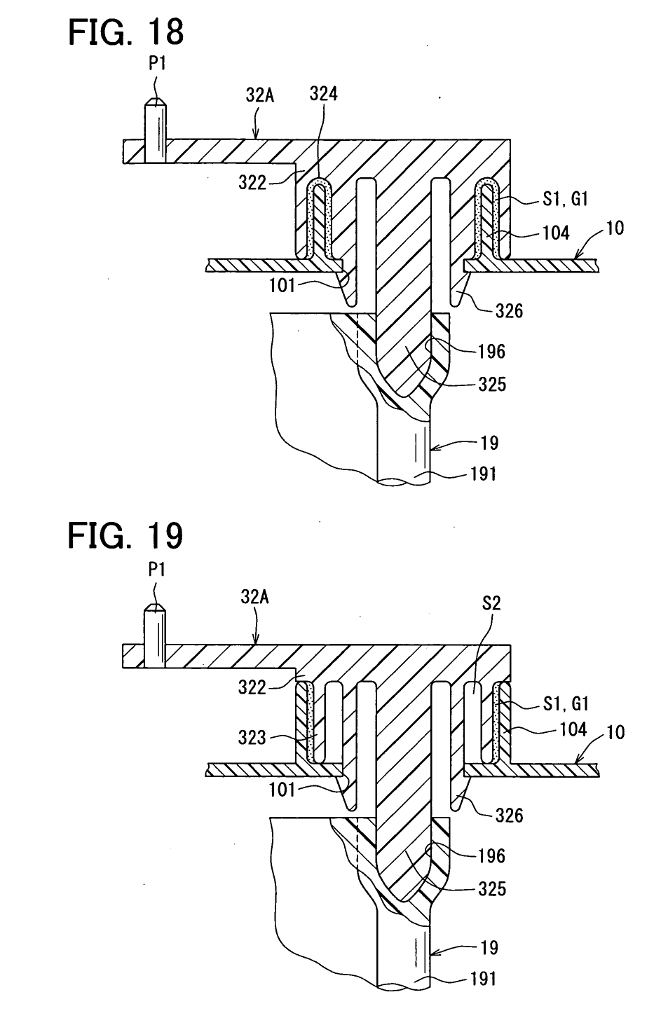

Referring to FIG. 18, in the sixteenth embodiment, the bearing part has a structure similar to that of the fifteenth embodiment, but the relationship between the projection and the groove is reversed. For example, the air conditioning case 10 has the fixed projection 104, in place of the fixed groove 103 of the fifteenth embodiment. The lever plate 32A has the rotational groove 324, in place of the rotational projection 323 of the fifteenth embodiment.

The fixed projection 104 is received in the rotational groove 324 such that the closed space S1 is provided between them. The closed space S1 is filled with the high-viscosity grease G1 so as to generate the predetermined slide resistance when the air mix door 19 rotates.

Accordingly, also in the present embodiment, the effects similar to the above embodiments will be provided.

### Seventeenth Embodiment

Referring to FIG. 19, in the seventeenth embodiment, the bearing part is constructed by employing the slide resistance generating part of the thirteenth embodiment to the bearing part of the fifteenth embodiment. The lever plate 32A has the rotational projection 323 projecting from the expanded portion 322 toward the air conditioning case 10, on the periphery of the pin 325. The rotational projection 323 has the cylindrical shape and is coaxial with the pin 325.

The air conditioning case 10 has the fixed projection 104 having the cylindrical shape on the periphery of the shaft hole 104. The fixed projection 104 projects from the outer surface of the air conditioning case 10 toward the lever plate 32A. The rotational projection 323 of the lever plate 32A is received in the fixed projection 104 such that the closed space S1 is provided between the outer circumferential surface of the rotational projection 323 and the inner circumferential surface of the fixed projection 104. The closed space S1 is filled with the high-viscosity grease G1 so as to generate the predetermined slide resistance when the air mix door 19 rotates.

Accordingly, also in the present embodiment, the effects similar to the above embodiments will be provided.

### Eighteenth Embodiment

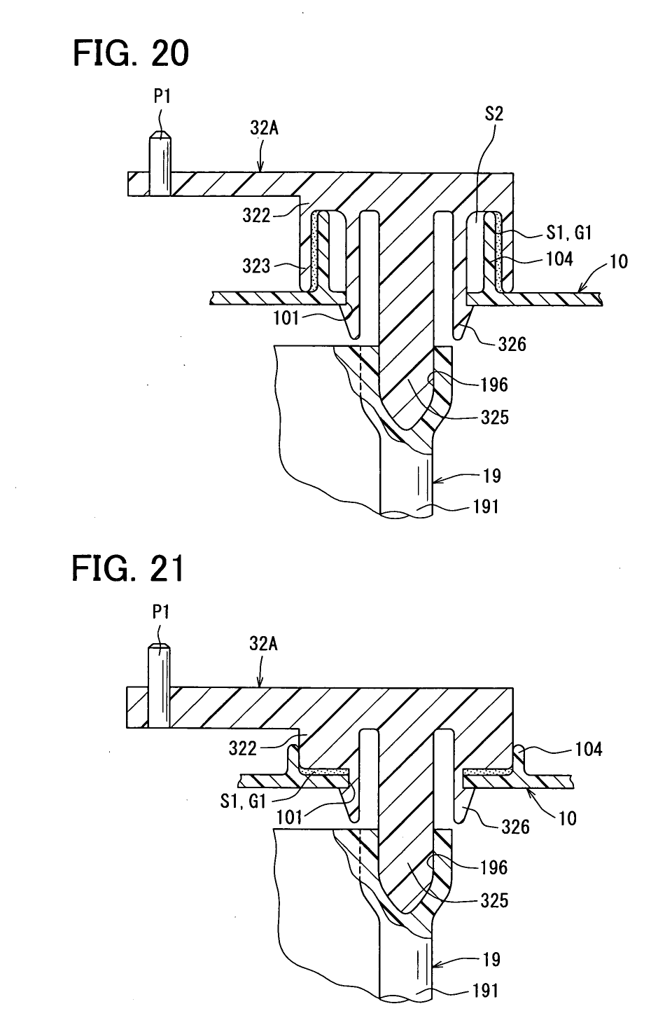

Referring to FIG. 20, in the eighteenth embodiment, the relationship between the projection and the groove of the bearing part is reversed from that of the seventeenth embodiment. Specifically, the rotational projection 323 of the lever plate 32A is located on an outer circumferential side of the fixed projection 104 of the air conditioning case 10. The closed space S1 is provided between the inner circumferential surface of the rotational projection 323 and the outer circumferential surface of the fixed projection 104. The closed space S1 is filled with the high-viscosity grease G1 so as to generate the predetermined slide resistance when the air mix door 19 door rotates. Accordingly, also in the present embodiment, the effects similar to the above embodiments will be provided.

### Nineteenth Embodiment

Referring to FIG. 21, in the nineteenth embodiment, the bearing part is constructed by employing the slide resistance generating part of the twelfth embodiment to the bearing part of the fifteenth embodiment.

The lever plate 32A has the expanded portion 322 on the periphery of the pin 325. The expanded portion 322 has a substantially disc shape. The air conditioning case 10 has the fixed projection 104 on the outer surface at a position corresponding to the expanded portion 322 of the lever plate 32A. The fixed projection 104 has the cylindrical shape and surrounds the expanded portion 322. The inner circumferential surface of the fixed projection 104 is in contact with an outer circumferential surface of the expanded portion 322.

The closed space S1 is provided between the axially outer surface of the expanded portion 322 and the outer surface of the air conditioning case 10. The closed space S1 is filled with the high-viscosity grease G1 so as to generate the predetermined slide resistance when the air mix door 19 rotates. Accordingly, also in the present embodiment, the effects similar to the above embodiments will be provided.

### Twentieth Embodiment

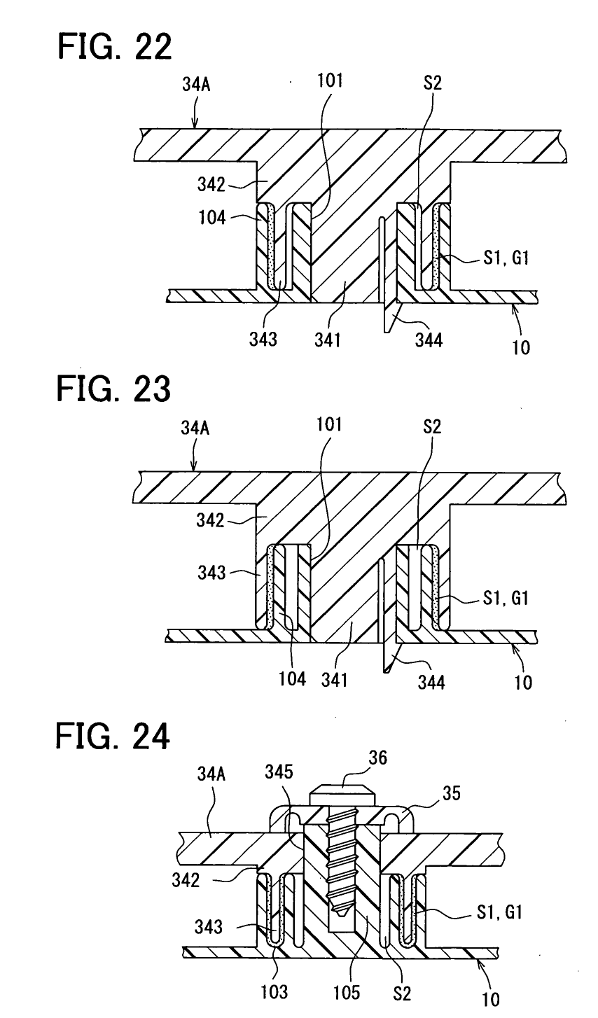

Referring to FIG. 22, in the twentieth embodiment, the link plate support part is constructed by employing the slide resistance generating part of the thirteenth embodiment to the link plate support part of the seventh embodiment. The link plate 34A has the boss portion 341 and the expanded portion 342 on the periphery of the boss portion 341. For example, the expanded portion 342 has the substantially disc shape, and the outer diameter of the expanded portion 342 is greater than that of the boss portion 341.

Further, the link plate 34A has the rotational projection 343 that projects from the surface of the expanded portion 342, the surface facing the air conditioning case 10. The rotational projection 343 has the cylindrical shape and is coaxial with the boss portion 341. The air conditioning case 10 has the fixed projection 104 on the periphery of the shaft hole. 101 to correspond to the rotational projection 343 of the link plate 34A. The fixed projection 104 has the cylindrical shape and projects from the outer surface of the air conditioning case 10.

The fixed projection 104 is opposed to the rotational projection 343 in the radial direction, and the closed space S1 is provided between the inner circumferential surface of the fixed projection 104 and the outer circumferential surface of the rotational projection 343. The closed space S1 is filled with the high-viscosity grease G1 so as to generate the predetermined slide resistance when the air mix door 19 rotates. Accordingly, also in the present embodiment, the effects similar to the above embodiments will be provided.

### Twenty-First Embodiment

Referring to FIG. 23, in the twenty-first embodiment, the relationship between the rotational projection 343 of the link plate 34A and the fixed projection 104 of the air conditioning case 10 is reversed from that of the twentieth embodiment. Specifically, the rotational projection 343 is located on the outer circumferential side of the fixed projection 104, and the closed space S1 is provided between the inner circumferential surface of the rotational projection 343 and the outer circumferential surface of the fixed projection 104. The closed space S1 is filled with the high-viscosity grease G1 so as to generate the predetermined slide resistance when the air mix door 19 rotates.

Accordingly, also in the present embodiment, the effects similar to the above embodiments will be provided.

### Twenty-Second Embodiment

Referring to FIG. 24, in the twenty-second embodiment, the air conditioning case 10 has a boss portion (support shaft) 105 that projects from the outer surface thereof toward the link plate 34A. The boss portion 105 is inserted to a boss receiving hole (rotational shaft hole) 345 of the link plate 34A, and fastened by a screw 36 through a washer 35 and the like. Thus, the link plate 34A is rotatably supported by the air conditioning case 10. The link plate support part of the twenty-second embodiment is constructed by employing the slide resistance generating part of the seventh embodiment between the air conditioning case 10 and the link plate 34A, which is coupled to the air conditioning case 10 in the above described manner.

The link plate 34A has the expanded portion 342 on a periphery of the boss receiving hole 345. The expanded portion 342 has the substantially disc shape and formed on the surface of the link plate 34A, the surface facing the air conditioning case 10. The link plate 34A further has the rotational projection 343 that projects from the expanded portion 342 toward the air conditioning case 10. The rotational projection 343 has the cylindrical shape and is coaxial with the boss receiving hole 345.

The air conditioning case 10 has the fixed groove 103 on the periphery of the boss portion 105 and on the outer side for receiving the rotational projection 343 of the link plate 34A. The fixed groove 103 has the annular shape that is coaxial with the boss portion 105.

The rotational projection 343 is received in the fixed groove 103 such that the closed space S1 is provided between them. The closed space S1 is formed continuously from the outer circumferential side of the rotational projection 343 to the inner side circumferential of the rotational projection 343 through the end of the rotational projection 343. Thus, the closed space S1 has the substantially U-shape in the cross-section defined in the axial direction as shown in FIG. 24.

The closed space S1 is filled with the high-viscosity grease G1 so as to generate the predetermined slide resistance when the air mix door 19 rotates. Accordingly, also in the present embodiment, the effects similar to the above embodiments will be provided.

### Twenty-Third Embodiment

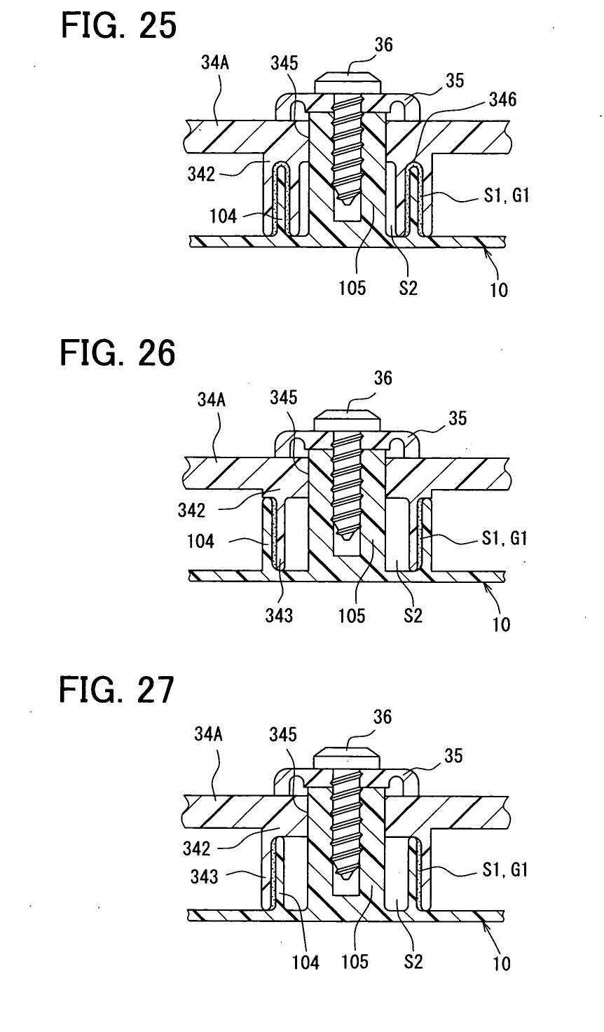

Referring to FIG. 25, in the twenty-third embodiment, the relationship between the projection and the groove of the link plate support part is reversed from that of the twenty-second embodiment. The link plate 34A has a rotational groove (rotatable-side groove) 346 on the expanded portion 342. The air conditioning case 10 has the fixed projection 104 on the periphery of the boss portion 105. The fixed projection 104 projects from the outer surface of the air conditioning case 10 toward the link plate 34A and has the cylindrical shape that is coaxial with the boss portion 105.

The fixed projection 104 is received in the rotational groove 346 such that the closed space S1 is provided between them. The closed space S1 is filled with the high-viscosity grease G1 so as to generate the predetermined slide resistance when the air mix door 19 rotates. Accordingly, also in the present embodiment, the effects similar to the above embodiment will be provided.

### Twenty-Fourth Embodiment

Referring to FIG. 26, in the twenty-fourth embodiment, the link plate support part is constructed by employing the slide resistance generating part of the thirteenth embodiment in the link plate support part of the twenty-second embodiment. The link plate 34A has the expanded portion 342 on the periphery of the boss receiving hole 345, and the rotational projection 343 having the cylindrical shape. The rotational projection 343 projects from the expanded portion 342 toward the air conditioning case 10 and is coaxial with the boss portion 105.

The air conditioning case 10 has the fixed projection 104 on the periphery of the boss portion 105. The fixed projection 104 projects from the outer surface of the air conditioning case 10 toward the link plate 34A and has the cylindrical shape to correspond to the rotational projection 343.

The rotational projection 343 is received in the fixed projection 104 such that the closed space S1 is provided between the outer circumferential surface of the rotational projection 343 and the inner circumferential surface of the fixed projection 104. The closed space S1 is filled with the high-viscosity grease G1 so as to generate the predetermined slide resistance when the air mix door 19 rotates. Accordingly, also in the present embodiment, the effects similar to the above embodiments will be provided.

### Twenty-Fifth Embodiment

Referring to FIG. 27, in the twenty-fifth embodiment, the link plate support part is constructed by reversing the relationship between the rotational projection 343 and the fixed projection 104 from that of the twenty-fourth embodiment. Specifically, the rotational projection 343 is located on the outer circumferential side of the fixed projection 104. In this case, the closed space S1 is provided between the inner circumferential surface of the rotational projection 343 and the outer circumferential surface of the fixed projection 104. The closed space S1 is filled with the high-viscosity grease G1 so as to generate the predetermined slide resistance when the air mix door 19 rotates. Accordingly, also in the present embodiment, the effects similar to the above embodiments will be provided.

### Twenty-Sixth Embodiment

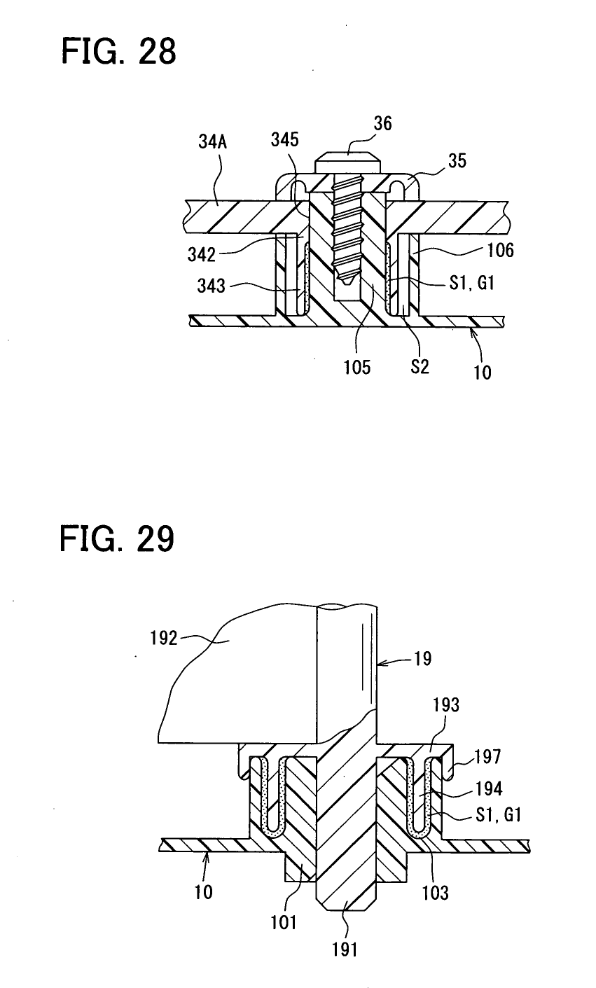

Referring to FIG. 28, in the twenty-sixth embodiment, the link plate support part is constructed by employing the slide resistance generating part of the tenth embodiment to the link plate support part of the twenty-second embodiment. The link plate 34A has the expanded portion 342 on the periphery of the boss receiving hole 345 and the rotational projection 343 projecting from the expanded portion 342 toward the air conditioning case 10. The rotational projection 343 has the cylindrical shape and is coaxial with the boss portion 105 of the air conditioning case 10.

The boss portion 105 is received in the rotational projection 343 and the boss receiving hole 345. The closed space S1 is provided between the inner circumferential surface of the rotational projection 343 and an outer circumferential surface of the boss portion 105. The closed space S1 is filled with the high-viscosity grease G1 so as to generate the predetermined slide resistance when the air mix door 19 rotates. The air conditioning case 10 has an outer ring portion (link supporting portion) 106 on the periphery of the slide resistance generating part across the space S2.

### Other Embodiments

FIG. 29 shows another embodiment of the bearing part. As shown in FIG. 29, the expanded portion 193 can have a rib 197 to surround the radially outer side of the slide resistance generating part. Even if the air mix door 19 is displaced in the axial direction (e.g., upward direction in FIG. 29) by a distance of thrust displacement, the closed space S1 is kept as in a closed space.

In the above embodiments, the slide resistance generating part is employed in association with the air mix door 19 that is disposed upstream of the heater core 21 in the air conditioning apparatus. However, the door to which the slide resistance generating part of the above embodiments is employed is not limited to the air mix door 19, but may be any doors. For example, in the air conditioning apparatus, another door such as a face/foot door that switches an air flow direction between the foot opening 28 and the face opening 26 at which the resistance to flow of the air is smaller than that at the foot opening 28 may have the self-induced vibration when the face/foot door is at a position where the face opening 26 is slightly opened. Thus, the slide resistance generating part of the above embodiments can be employed in connection with the face/foot door.

Further, the slide resistance generating part of the above embodiments may be employed in connection with the inside/outside air switching door 12, the air-blowing mode switching doors 25, 27, 29 and the like. In the above embodiments, the doors are operated by the motors. However, the doors can be constructed as to be operated manually.

Moreover, in the above embodiments, the bearing part and the link plate support part are employed to the air conditioning apparatus for a vehicle. However, the slide resistance generating part may be employed to other air conditioners such as a fixed-type air conditioner.

In a rotatable door that is operable to open and close an opening, when the door is at a position where the opening is slightly opened, the velocity of the air flowing into the opening through a small clearance is increased, and a differential pressure between an upstream side and a downstream side of the door is increased. As a result, the self-induced vibration of the door is caused. Thus, the present invention may be employed to any doors for reducing the self-induced vibration.

Further, the object that supports the rotatable member through the above slide resistance generating part is not limited to the air conditioning case 10. The slide resistance generating part may be employed to generate the slide resistance in any rotatable members that are rotatably supported on other members.

Additional advantages and modifications will readily occur to those skilled in the art. The invention in its broader term is therefore not limited to the specific details, representative apparatus, and illustrative examples shown and described.

What is claimed is:

1. An air conditioning apparatus comprising:
a case;
a rotatable member rotatably supported through the case such that a surface of the rotatable member is opposed to a surface of the case, and a closed space is provided between the opposed surfaces of the case and the rotatable member; and
a viscous fluid having a predetermined coefficient of viscosity, wherein the closed space is filled with the viscous fluid.

2. The air conditioning apparatus according to claim 1, wherein
the case has a shaft hole and a projection on a periphery of the shaft hole,
the rotatable member has a rotation shaft,
the rotation shaft is received in the shaft hole of the case such that an outer surface of the rotation shaft is opposed to an inner surface of the projection, and
the closed space is provided between the outer surface of the rotation shaft and the inner surface of the projection.

3. The air conditioning apparatus according to claim 1, wherein
the rotatable member has a rotation shaft and an expanded portion on a periphery of the rotation shaft, and
the rotatable member is disposed such that a surface of the expanded portion is opposed to the surface of the case, and the closed space is provided between the surface of the expanded portion and the surface of the case.

4. The air conditioning apparatus according to claim 1, wherein
the rotatable member has a rotation shaft, an expanded portion on a periphery of the rotation shaft, and a rotational projection that projects from the expanded portion and is located on the periphery of the rotation shaft,
the case has a shaft hole that receives the rotation shaft of the rotatable member and a fixed projection on the periphery of the shaft hole, and
the rotational projection and the fixed projection are disposed such that the closed space is provided between one of an inner surface and an outer surface of the rotational projection and one of an inner surface and an outer surface of the fixed projection.

5. The air conditioning apparatus according to claim 4, wherein
the fixed projection has a cylindrical shape and the shaft hole is defined by an inner circumferential surface of the fixed projection,
the fixed projection is received in the rotational projection such that an outer circumferential surface of the fixed projection is opposed to the inner surface of the rotational projection.

6. The air conditioning apparatus according to claim 1, wherein
the case has a support shaft and a fixed projection on a periphery of the support shaft,
the rotatable member has a shaft hole that receives the support shaft of the case, an expanded portion on a periphery of the shaft hole, and a rotational projection that projects from the expanded portion, and
the rotational projection and the fixed projection are disposed such that the closed space is provided between one of an inner surface and an outer surface of the rotational projection and one of an inner surface and an outer surface of the fixed projection.

7. The air conditioning apparatus according to claim 1, wherein
the rotatable member has a rotational projection that has a cylindrical shape and is located on a periphery of a rotation axis of the rotatable member,
the case has a fixed projection that has a cylindrical shape and is located on a periphery of the rotation axis,
one of the rotational projection and the fixed projection is received in the other of the rotational projection and the fixed projection such that an outer circumferential surface of the one is opposed to an inner circumferential surface of the other, and
the closed space is provided between the outer circumferential surface of the one and the inner circumferential surface of the other.

8. The air conditioning apparatus according to claim 1, wherein
the rotatable member has a rotation shaft, an expanded portion on a periphery of the rotation shaft, and a rotational projection that projects from the expanded portion and is located on a periphery of the rotation shaft,
the case has a shaft hole that receives the rotation shaft of the rotatable member, and a fixed groove on a periphery of the shaft hole, and
the rotational projection is engaged with the fixed groove such that the closed space is provided between an outer surface of the rotational projection and an inner surface of the fixed groove.

9. The air conditioning apparatus according to claim 1, wherein
the rotatable member has a rotation shaft, an expanded portion on a periphery of the rotation shaft, and a rotational groove that is defined in the expanded portion,
the case has a shaft hole that receives the rotation shaft of the rotatable member, and a fixed projection on a periphery of the shaft hole, and
the fixed projection is engaged with the rotational groove such that the closed space is provided between an outer surface of the fixed projection and an inner surface of the rotational groove.

10. The air conditioning apparatus according to claim 1, wherein
the case has a support shaft and a fixed groove on a periphery of the support shaft,
the rotatable member has a shaft hole that receives the support shaft of the case, an expanded portion on a periphery of the shaft hole, and a rotational projection projecting from the expanded portion, and
the rotational projection of the rotatable member is engaged with the fixed groove of the case such that the closed space is provided between an outer surface of the rotational projection and an inner surface of the fixed groove.

11. The air conditioning apparatus according to claim 1, wherein
the case has a support shaft and a fixed projection on a periphery of the support shaft,
the rotatable member has a shaft hole that receives the support shaft of the case, an expanded portion on a periphery of the shaft hole, and a rotational groove defined in the expanded portion, and
the fixed projection of case is engaged with the rotational groove of the rotatable member such that the closed space is provided between an outer surface of the fixed projection and an inner surface of the rotational groove.

12. The air conditioning apparatus according to claim 1, wherein
one of the rotatable member and the case has a projection that has a cylindrical shape on a periphery of a rotation axis of the rotatable member,
the other of the rotatable member and the case has a groove that has an annular shape on the periphery of the rotation axis, and
the projection is received in the groove such that the closed space is provided between an outer surface of the projection and an inner surface of the groove.

13. The air conditioning apparatus according to claim 12, wherein
the closed space is provided continuously from an outer circumferential side of the projection to an inner circumferential side of the projection through an end of the projection.

14. The air conditioning apparatus according to claim 1, wherein
the rotatable member has a first projection and a first groove on a periphery of a rotation axis of the rotatable member,
the case has a second projection and a second groove on the periphery of the rotation axis, and
the first projection and the first groove of the rotatable member are engaged with the second groove and the second projection of the case, respectively, such that the closed space is provided therebetween.

15. The air conditioning apparatus according to claim 1, wherein
the case defines an opening through which air flows, and
the rotatable member is a door that is disposed in the case and operable to open and close the opening of the case.

16. The air conditioning apparatus according to claim 1, further comprising:
a first heat exchanger disposed in the case for generating a cool air;
a second heat exchanger disposed in the case at a position downstream of the first heat exchanger with respect to a flow of air for heating the cool air;
a heating air passage provided in the case and through which air passing through the second heat exchanger flows; and
a bypass passage provided in the case and through which the cool air flows while bypassing the heating air passage, wherein
the rotatable member is an air mix door that is disposed in the case at a position upstream of the second heat exchanger, and
the air mix door is rotatable to control a ratio of an opening degree of the heating air passage to an opening degree of the bypass passage.

17. The air conditioning apparatus according to claim 1, further comprising:
a door member disposed in the case to control a passage defined in the case, wherein
the rotatable member is a lever plate that is coupled to the door for transmitting a rotational force to the door.

18. The air conditioning apparatus according to claim 1, further comprising:
a door member disposed in the case to control a passage defined in the case; and
a link mechanism coupled to the door member to operate the door member, wherein
the link mechanism includes a link plate and a lever plate,
the link plate is coupled to the door member through the lever plate such that a rotational force is transmitted from the link plate to the door member through the lever plate, and
the rotatable member is the link plate.

19. A passage control device comprising:
a case defining a passage through which a gas flows, the case having a case engagement portion;
a rotatable member configured to be rotatable with respect to the case to control the passage, the rotatable member having a rotational engagement portion that is rotatably engaged with the case engagement portion and a closed space is provided between the rotational engagement portion and the case engagement portion; and
a viscous fluid having a predetermined coefficient of viscosity, wherein
the closed space is filled with the viscous fluid so that a predetermined resistance to rotate the rotatable member is generated.

20. The passage control device according to claim 19, further comprising:
a door rotatably disposed in the case to open and close the passage; and
a link member that is rotatably supported by the case and configured to transmit a rotational force to the door, wherein
the rotatable member is at least one of the door and the link member.
